(19) United States
(12) Patent Application Publication
(10) Pub. No.: US 2007/0112929 A1
(43) Pub. Date: May 17, 2007

(54) Method, device and software for automatic notification about delayed meeting participation

(76) Inventor: Esa Etelapera, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 11/274,749

(22) Filed: Nov. 14, 2005

(51) Int. Cl. G06F 15/16

(52) U.S. Cl. 709/207; 709/206

(57) ABSTRACT

A method, device, and software product are presented for providing a notification of lateness regarding an appointment entered in a calendar. This notification is sent from a first appointment participant to at least one other appointment participant. The notification occurs when the first appointment participant receives a first appointment reminder for the appointment entered in the calendar, and then requests a later second appointment reminder. In that event, the calendar of the first appointment participant is automatically checked to identify the at least one other appointment participant, and the notification signal is automatically transmitted to the at least one other appointment participant, indicative of the lateness. Later, the second appointment reminder is sent to the first appointment participant.

### FIELD OF THE INVENTION

This invention relates to communication devices that are used for calendaring.

### BACKGROUND OF THE INVENTION

A mobile device or personal computer (PC) can be equipped to send an alarm to a user when an appointment or meeting is set to begin. Likewise, an alarm can also be sent to the user earlier, in order to notify the user that the meeting is scheduled to begin within a certain time.

However, the user may not be able to attend the meeting on time, because of a delay. Typically, in this type of situation, the user is in a hurry, and therefore will not want to take time to contact other meeting participants in order to tell them of the delay. Contacting those participants would probably make the user more late. Thus, there is a need for an efficient way to notify other meeting participants of lateness, without increasing the lateness.

Of course, it is known for an alarm clock to awaken a user, and it is also known for a user to postpone the awakening time by hitting a “snooze” button. It is also known to employ this type of postponement functionality with regard to meetings instead of for awakening. This postponement functionality is often called a “snooze” function, even if sleeping is not involved. For example, the COMPUCALENDAR 1.0.1 from COMPUNAC provides appointment reminders adjustable from zero to sixty minutes prior to an appointment, with a snooze alarm. See http://www.downlinx.com/proghtml/262/26257.htm (downloaded Nov. 1, 2005).

There is a need to relieve the user of contacting other meeting participants, so that the user will not be even more late. If a second person is told that a first person is going to be late, then the second person's plans can be altered accordingly, or the second person may seek to reschedule the meeting rather than wait. In either event, it would help the second person to hear from the first person, without exacerbating the first person's lateness.

### SUMMARY OF THE INVENTION

The present invention combines the snooze-type function of an alarm, together with a “sorry I'm late” message. In other words, the invention enables automatic notification of delayed participation in a meeting, the notification being triggered by a postponement action using a calendar alarm.

For example, suppose that a meeting is set to begin at 1 PM, and thus at 1 PM a user's mobile device provides an alarm to the user. During the alarm, the user can press a postponement button that has the snooze-type functionality. Thus, if the user hits the postponement button, then the user will be reminded again a certain time later. Additionally, according to the present invention, a message will automatically be sent to other meeting participants (or only to a single meeting organizer) saying that the user is running late. This lateness message is automatically sent by accessing contact information via the calendar which lists the appointment.

Likewise, the alarm may be programmed to remind the user a certain time before the appointment is set to begin. Again, if the user hits the postponement button, then the alarm will be postponed to a certain time later, and also a message will be automatically sent to at least one other meeting participant to indicate that the user is running late.

It is possible for the user to select whether the automatic lateness message is sent or not. For example, the user device can be programmed so that the lateness message will only be sent if the user hits the postponement button twice, when the alarm goes off. Thus, hitting the postponement button only once would cause the alarm to send a reminder a certain time later, but hitting would not cause any other meeting participants to be notified. However, if the postponement button is hit twice, then the device can send the lateness message, after possibly giving the user an opportunity to attach an oral statement to the lateness message, or giving the user an opportunity to indicate an estimated time of arrival.

When another meeting participant receives an automatic lateness message, that other participant's own calendar can be automatically annotated accordingly. The lateness message would preferably indicate who the lateness message has been sent to, and therefore the other meeting participant's wireless device can automatically forward the lateness message to any further meeting participants. Throughout this application, the words “meeting” and “appointment” are used interchangeably in a broad sense, to indicate any type of situation involving more than one person.

### BRIEF DESCRIPTION OF THE DRAWINGS

FIG. 1 is a method according to an embodiment of the present invention.

FIG. 2 is a block diagram of an electronic device according to an embodiment of the present invention.

### DETAILED DESCRIPTION OF THE INVENTION

According to an embodiment of the present invention, when the calendar alarm is shown to a person by a mobile device or personal computer (PC), then the person is given an option to “delay and inform the organizer about the delay.” The alarm can be in various forms, including a sound, a vibration, and/or an item on a display, and the option can also be in these various forms. If the person selects the option, then the system checks who the organizer of the meeting is, and sends a message (e.g. short message, email, or instant message) with predefined content, such as “I'll be late for the meeting X minutes,” where X is a pre-selected or currently selected delay time. The main advantage of this invention is that the user's time is saved in a situation where he or she is already late, because the user will not have to personally contact and speak with the meeting organizer.

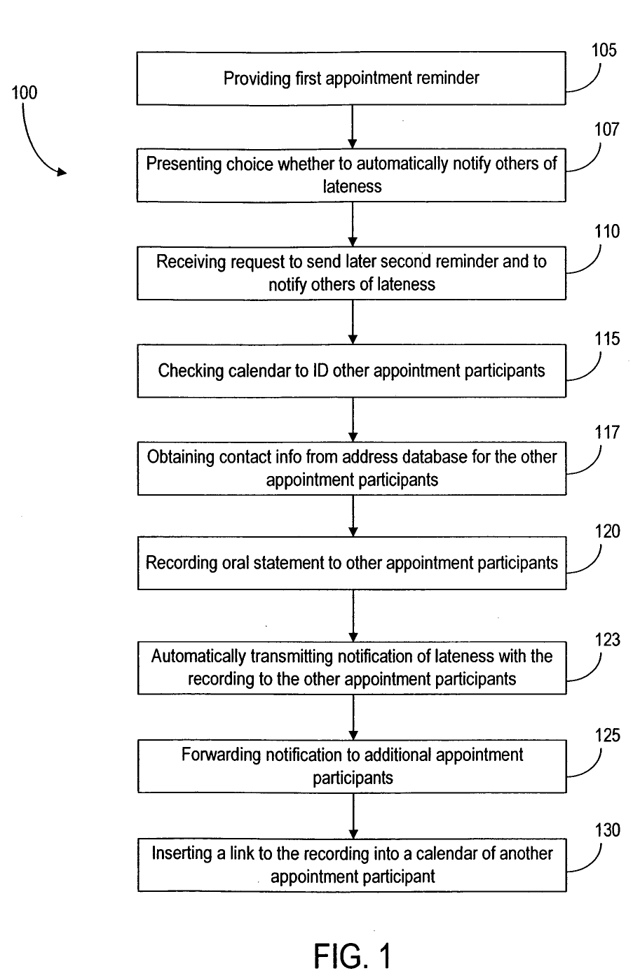

A method 100 according to an embodiment of the invention is shown in FIG. 1. A first appointment reminder is provided 105 by the user's device. This occurs when a calendar within the device indicates an appointment is scheduled to occur. The user is then presented with a choice whether to automatically notify 107 others of lateness. The device then receives 110 a request from the user to send a later second reminder and to go ahead and notify others of the lateness, instead of sending the later second reminder without notifying others. Subsequently, the user device automatically checks the user's calendar information to identify 115 other appointment participants (i.e. other people who are scheduled to attend the appointment). Then the device can obtain 117 contact information for those other appointment participants, from an address database. The notification of lateness can include a recorded 120 oral statement. In any event, the notification is then transmitted 123 to the other appointment participants. Upon receipt of the notification, the other appointment participants can automatically forward 125 the notification to additional appointment participants who were not listed as recipients of the initial notification. Also, the notification message and/or the attached recording can be linked 130 in the calendar of at least one of the other appointment participants.

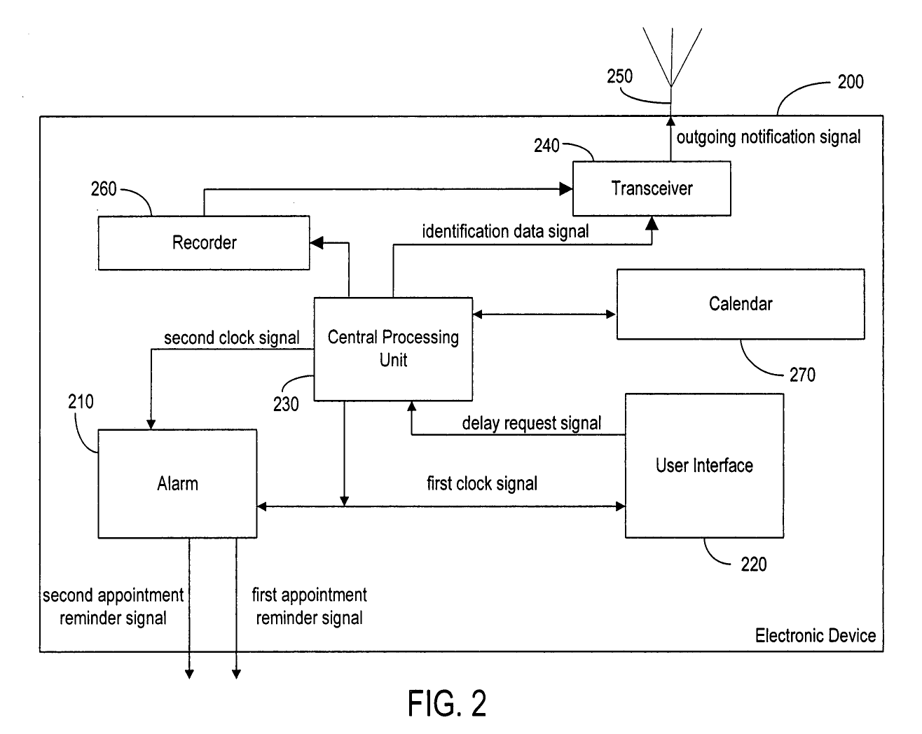

An electronic device 200 according to an embodiment of the invention is shown in FIG. 2. This can either be a mobile device, or a personal computer (PC) or the like. An alarm 210 receives a first clock signal from a central processing unit 230 indicating that an appointment is scheduled to begin now or within a certain time, and so the alarm provides a first reminder signal to the user. A user interface 220 also receives the first clock signal, and thus the user interface 220 can enable the user to send a request signal to the central processing unit 230 requesting a later second appointment reminder and also requesting automatic notification of other participants so that they are aware the user is going to be late. The CPU 230 checks the calendar 270 for information about the other meeting participants, and then sends that identification information to the transceiver 240 which transmits the notification signal via the antenna 250. Later, the CPU sends the second clock signal to the alarm 210, and so the alarm provides the second appointment reminder to the user. It is possible for the electronic device to also be equipped with a recorder 260 for recording a message that the transceiver 240 attaches to the outgoing notification signal.

According to this embodiment of the invention, the first clock signal is sent from the CPU 230 at an adjustable interval from zero to sixty minutes prior to the appointment that is entered in the calendar. Likewise, the second clock signal is also sent from the CPU 230 to the alarm 210 at another adjustable interval less than sixty minutes.

The electronic device 200 is also equipped to receive an incoming notification of lateness. In that case, the calendar 270 can be automatically annotated to indicate lateness, and/or a link can be inserted into the calendar 270 linking to information about the incoming notification of lateness (e.g. linking to an attached voice recording from another meeting participant).

It is to be understood that all of the present figures, and the accompanying narrative discussions of best mode embodiments, do not purport to be completely rigorous treatments of the method, system, mobile device, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various different combinations of hardware and software which need not be further detailed herein.

What is claimed is:

1. A method of providing a notification of lateness for an appointment, the appointment being entered in a calendar database of a user device belonging to a first appointment recipient, the notification being sent from the user device of the first appointment participant to at least one other appointment participant, the method comprising:
providing from the user device to the first appointment participant a first appointment reminder for the appointment entered in the calendar;
receiving at the user device a request from the first appointment participant to later send a second appointment reminder;
checking the calendar of the first appointment participant to identify the at least one other appointment participant;
automatically transmitting a notification signal, indicative of the lateness, to the at least one other appointment participant; and
later sending the second appointment reminder to the first appointment participant.

2. The method of claim 1, further comprising a step, before the receiving step, of presenting a choice to the first appointment participant whether to request the second appointment reminder with, instead of without, automatically notifying the at least one other appointment participant.

3. The method of claim 1,
wherein the notification signal comprises an identification of the at least one other appointment participants to whom the notification signal is sent; and
wherein the method further comprises the step of forwarding the notification signal to at least one additional appointment participant who was not included in the identification.

4. The method of claim 1, further comprising a step, after the checking step, of obtaining at least one contact information from an address database, for sending the notification signal to the at least one other appointment participant.

5. The method of claim 2, wherein the choice is made by hitting a button twice instead of once.

6. The method of claim 1,
wherein the providing step is performed at a first adjustable interval prior to the appointment entered in the calendar; and
wherein the second appointment reminder follows the first appointment reminder by a second adjustable interval.

7. The method of claim 1, further comprising:
recording an oral statement from the first appointment participant to the at least one other appointment participant; and
attaching the statement to the notification signal.

8. The method of claim 1, further comprising the step of annotating an other calendar, of the at least one other appointment participant, to indicate the lateness in response to the notification signal.

9. The method of claim 8, wherein a link is inserted into the other calendar of the at least one other appointment participant, linking to a recorded oral statement that was attached to the notification signal.

10. The method of claim 1, further comprising the step of alerting the first appointment participant if the notification signal is not successfully transmitted.

11. An electronic device that provides a notification of lateness for an appointment entered in a calendar, the notification being sent from a first appointment participant, to at least one other appointment participant, the electronic device comprising:
an alarm, responsive to a first clock signal, for providing to the first appointment participant a first appointment reminder signal for the appointment entered in the calendar;
a user interface, responsive to the first clock signal, for enabling the first appointment participant to initiate a request signal requesting a later second appointment reminder;
a central processing unit, responsive to the request signal, for checking the calendar of the first appointment participant to identify the at least one other appointment participant; and
a transceiver, for automatically transmitting an outgoing notification signal, indicative of the lateness, to the at least one other appointment participant, in response to an identification data signal from the central processing unit;
wherein the alarm is also for later sending a second appointment reminder signal to the first appointment participant, in response to a second clock signal, and
wherein the central processing unit is also for providing the first clock signal and the second clock signal.

12. The electronic device of claim 11, wherein the user interface is also for presenting a choice to the first appointment participant whether to initiate the request signal requesting the second appointment reminder with, instead of without, automatic notification of the at least one other appointment participant.

13. The electronic device of claim 11,
wherein the notification signal comprises an identification of the at least one other appointment participants to whom the notification signal is sent; and also comprises a request to forward the notification signal to at least one additional appointment participant who was not included in the identification.

14. The electronic device of claim 11, further comprising an address database for providing contact information that is included in the identification data signal.

15. The electronic device of claim 12, wherein the user interface comprises a button configured to enable the first appointment participant to make the choice by pressing the button twice instead of once.

16. The electronic device of claim 11,
wherein the first clock signal is sent at a first adjustable interval prior to the appointment entered in the calendar; and
wherein the second clock signal follows the first clock signal by a second adjustable interval.

17. The electronic device of claim 11, further comprising:
a recorder for creating a recording of an oral statement from the first appointment participant to the at least one other appointment participant, the recording being for inclusion in the outgoing notification signal to the at least one other appointment participant.

18. The electronic device of claim 11, further comprising means for annotating the calendar, of the first appointment participant, to indicate lateness in response to an incoming notification signal from the at least one other appointment participant.

19. The electronic device of claim 18, wherein a link is inserted into the calendar of the first appointment participant, linking to a recorded oral statement that was attached to the incoming notification signal.

20. The electronic device of claim 11, wherein the user interface is also for alerting the first appointment participant if the outgoing notification signal is not successfully transmitted to the at least one other appointment participant.

21. A computer readable medium encoded with a software data structure for performing the method of claim 1.

22. A software product that is used to provide a notification of lateness for an appointment entered in a calendar, the notification being sent from a first appointment participant to at least one other appointment participant, the software product comprising a computer readable medium having executable codes embedded therein; the codes, when executed, adapted to carry out the steps of:
providing to the first appointment participant a first appointment reminder for the appointment entered in the calendar;
receiving a request from the first appointment participant to later send a second appointment reminder, and to now automatically notify the at least one other appointment participant of the lateness;
checking the calendar of the first appointment participant to identify the at least one other appointment participant;
automatically transmitting a notification signal, indicative of the lateness, to the at least one other appointment participant; and
later sending a second appointment reminder to the first appointment participant.
